(19) United States
(12) Patent Application Publication
(10) Pub. No.: US 2011/0234167 A1
(43) Pub. Date: Sep. 29, 2011

(54) Method of Predicting Remaining Capacity and Run-time of a Battery Device

(76) Inventors: Chin-Hsing Kao, Taoyuan County (TW); Chun-Ming Chen, Hsinchu City (TW); Tien-Chung Tso, Hsinchu County (TW)

(21) Appl. No.: 12/917,489

(22) Filed: Nov. 2, 2010

Related U.S. Application Data
(60) Provisional application No. 61/316,837, filed on Mar. 24, 2010.

(51) Int. Cl. H02J 7/00

(52) U.S. Cl. 320/132; 320/136

(57) ABSTRACT

Estimating remaining capacity and remaining time of a battery device during discharging of the battery device includes determining initial state of charge of the battery device, determining discharge current of the battery device, utilizing a shooting end of discharge process to determine final state of charge corresponding to the discharge current, and determining the remaining capacity and the remaining time according to the final state of charge.

### CROSS REFERENCE TO RELATED APPLICATIONS

This application claims the benefit of U.S. Provisional Application No. 61/316,837, filed on Mar. 24, 2010, and entitled “Method and Apparatus for the Prediction of Battery Remaining Capacity and Remaining Run Time,” the contents of which are incorporated herein by reference.

### BACKGROUND OF THE INVENTION

1. Field of the Invention

The present invention relates to battery devices, and more particularly to a method of predicting remaining capacity and run-time of a battery.

2. Description of the Prior Art

Modern batteries provide power to portable electronic devices. A gas gauge device is required in modern batteries for providing a user with information about remaining capacity and remaining run-time of the battery. In current generation battery technology, an impedance track algorithm for estimating battery capacity tracks internal impedance variation of the battery after battery current stabilizes in a discharging process. Utilizing a related database, voltage simulation is performed to estimate remaining capacity (RM) of the battery with error lower than 1%. Initially, the battery may already be discharged from full charge (DOD_{charge}) to current charge (DOD₀). Remaining capacity (RM) may vary depending on load current of the battery. A dotted line in FIG. 2 shows open circuit voltage (OCV) as a function of DOD. As shown by a solid line in FIG. 2, under a load, the battery may reach a termination voltage, e.g. 3.0 Volts, having only discharging 95% of total charge of the battery.

Taking a notebook computer as an example, it is difficult for battery current thereof to reach steady state during discharging of the battery. Thus, if battery characteristics utilized for predicting remaining capacity and remaining run-time are measured during discharging, current variations due to different use patterns by the user may lead to errors in measuring the battery characteristics. Further, as shown in FIG. 1, it can be seen that the internal resistance tracked by the impedance track algorithm includes a frequency-related factor, which increases estimation error. As shown in FIG. 2, depth of discharge (DOD) corresponding to termination voltage is estimated by calculating a battery voltage for each 4% increase of DOD. The dashed line in FIG. 2 represents open circuit voltage (OCV), and the solid line in FIG. 2 represents voltage when the battery is connected to a load. Starting from an initial candidate DOD, e.g. 0%, battery voltage under the current load is estimated. As long as the estimate battery voltage is greater than the termination voltage, the candidate DOD is iteratively increased by 4%, until the estimated battery voltage drops below the termination voltage. In a worst case scenario, 25 iterations are required to achieve 4% error. For this method to achieve 1% error, number of calculation intervals must be increased (made finer), leading to increased calculation burden and battery power consumption, as well as a reduction in speed. Thus, the method described above is prone to error due to discharge current variations, and requires a high number of calculations to iteratively arrive at an accurate prediction of remaining capacity and remaining run-time.

### SUMMARY OF THE INVENTION

According to an embodiment, a method of estimating remaining capacity and remaining time of a battery device during discharging of the battery device comprises the battery device determining initial state of charge of the battery device, a coulomb counter of the battery device determining discharge current of the battery device, a microprocessor of the battery device utilizing a shooting end of discharge process to determine final state of charge corresponding to the discharge current, and the microprocessor determining the remaining capacity and the remaining time according to the final state of charge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a load profile corresponding to load frequency and power characteristics according to the prior art.

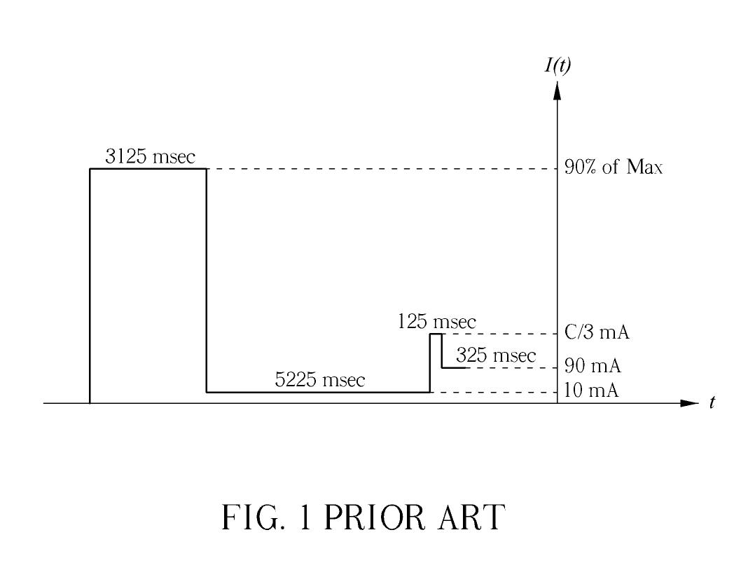

FIG. 2 is a diagram illustrating a voltage simulation for calculating depth of discharge at the end of discharge (EOD) according to the prior art.

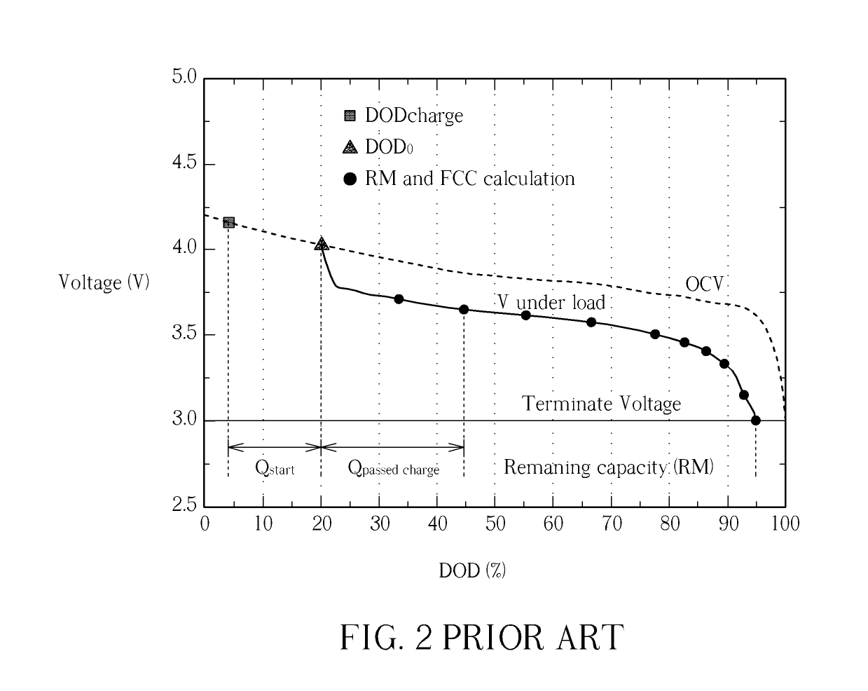

FIG. 3 is a block diagram of a battery device.

FIG. 4 is a block diagram of a smart battery device.

FIG. 5 is a flowchart of a process for predicting remaining capacity and run-time of a battery of a battery device.

FIG. 6 is a diagram of a shooting EOD process according to an embodiment.

FIG. 7 is a diagram illustrating estimated battery voltage versus state of charge for various discharge currents.

FIG. 8 is a diagram illustrating three cases for estimating state of charge at the end of discharge for low, high, and middle discharge current.

FIG. 9 is a diagram illustrating a typical battery charging profile.

### DETAILED DESCRIPTION

Embodiments described herein provide a method of estimating remaining capacity and remaining run-time of a battery, including self-adaptive battery characteristics, and reduced calculation load.

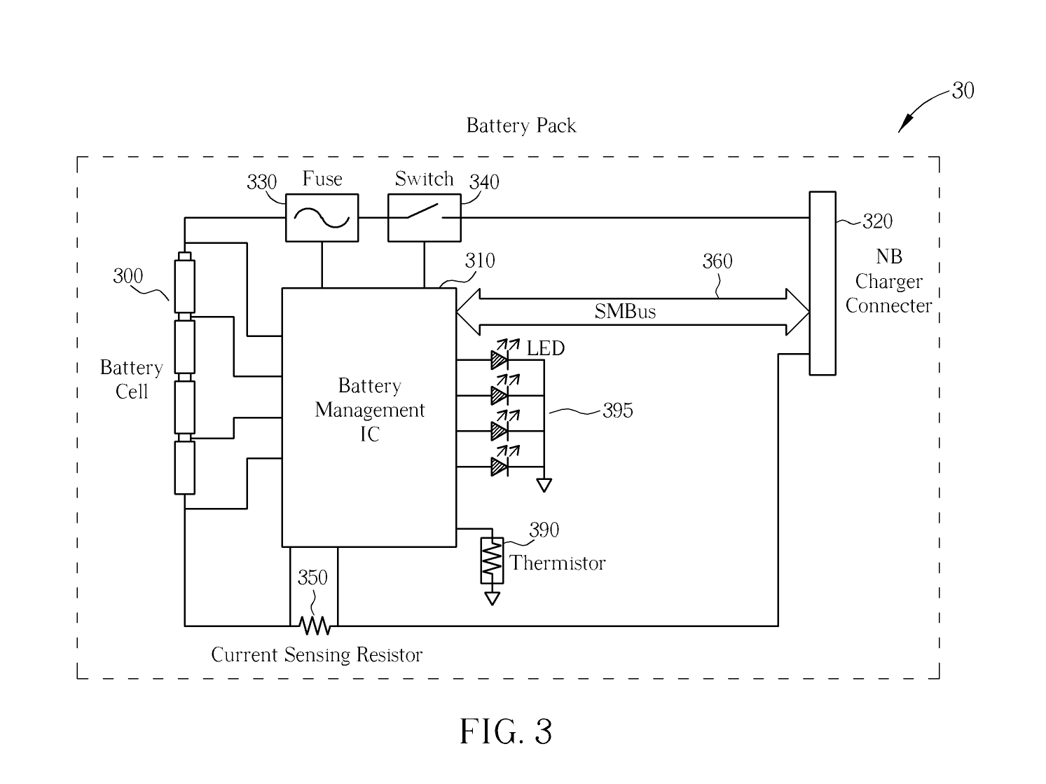

Please refer to FIG. 3, which is a block diagram of a battery device 30. The battery device 30 may be installed in a housing, and may be electrically connected to a notebook computer for powering internal circuits and electrical devices, such as a hard disk drive and a liquid crystal display (LCD), of the notebook computer. The battery device 30 may comprise a plurality of battery cells 300, a battery management integrated circuit (IC) 310, and a notebook charger connector 320 installed in the housing. The notebook charger connector 320 may be electrically connected to a positive terminal (+) and a negative terminal (−) of the plurality of battery cells 300. The notebook charger connector 320 may be electrically connected to the positive terminal of the plurality of battery cells 300 through a fuse 330 and a switch 340, and may be electrically connected to the negative terminal of the plurality of battery cells 300 through a current sensing resistor 350. Gas gauge and status messages, as well as control signals, may be transferred between the battery management IC 310 and the notebook charger connector 320 through a System Management Bus (SMBus) 360. The plurality of battery cells 300 may provide direct current (DC) power to the notebook computer at a voltage level ranging from 9 Volts to 17 Volts, though higher or lower voltages may also provided by the plurality of battery cells 300 for powering the notebook computer. The plurality of battery cells 300 may be arranged in any combination of series and parallel connections. For example, as shown in FIG. 3, the plurality of battery cells 300 may comprise four individual battery cells arranged in series. The battery management IC 310 may control the fuse 330 and the switch 340 for preventing overcurrent and/or overvoltage events from damaging the notebook computer. The switch 340 may be a transistor having a control terminal electrically connected to the battery management IC 310. The battery management IC 310 may also be electrically connected to first and second terminals of the current sensing resistor 350 for detecting the overcurrent event. The battery management IC 310 may have a terminal electrically connected to a thermistor 390 for regulating output of the DC power in response to temperature variations detected through the thermistor 390. The battery management IC 310 may also control a plurality of light-emitting diodes (LEDs) 395 for providing battery status messages to a user of the notebook computer. The plurality of LEDs 395 may be visible through the housing.

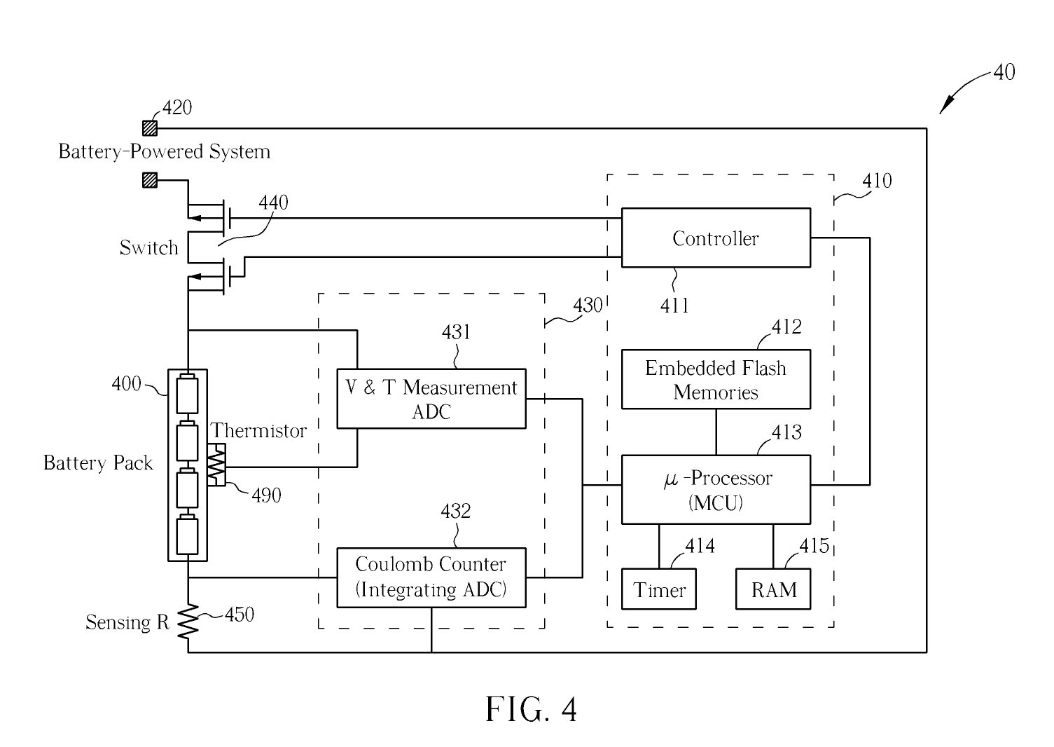

Please refer to FIG. 4, which is a block diagram of a smart battery device 40. The smart battery device 40 may comprise a battery pack 400, an adaptive control circuit 410, a charger connecter 420, an analog preprocessing circuit 430, a switch 440, a sense resistor 450, and a thermistor 490. The adaptive control circuit 410 may comprise a microprocessor 413, embedded flash memory 412, a timer 414, random access memory (RAM) 415, and a control circuit 411. The analog preprocessing circuit 430 may comprise a voltage and temperature measurement analog-to-digital converter (ADC) 431, and a Coulomb counter 432. The Coulomb counter 432 may be considered an integrating ADC.

The battery pack 400 may comprise a plurality of battery cells. The battery cells may be arranged in any combination of serial and parallel. The adaptive control circuit 410 may be utilized for controlling on and off states of the switch 440 for selectively connecting or disconnecting the battery pack 400 to or from an external electronic device through the external adapter 420. The microprocessor 413 may send a signal to the charge control circuit 411 for turning the switch 440 on or off according to the signal received from the microprocessor 413. The voltage and temperature measurement ADC 431 may have a first input electrically connected to the thermistor 490 for receiving a temperature signal related to temperature of the battery pack 400, and may have a second input electrically connected to the battery pack 400 for receiving a voltage level of the battery pack 400. The voltage and temperature measurement ADC 431 may convert the voltage level and the temperature signal into a digital voltage signal and a digital temperature signal, respectively, both of which may be sent to the microprocessor 413. The Coulomb counter 432 may have a first input electrically connected to a first end of the sense resistor 450, and a second input electrically connected to a second end of the sense resistor 450. A voltage drop across the sense resistor 450 may be detected by the Coulomb counter 432, integrated over time, and digitized into a battery charge signal sent to the microprocessor 413 through an output of the Coulomb counter 432 electrically connected to the microprocessor 413. The embedded flash memory 412 may store charging characteristics, use history, firmware, and a database. The use history may include aging information.

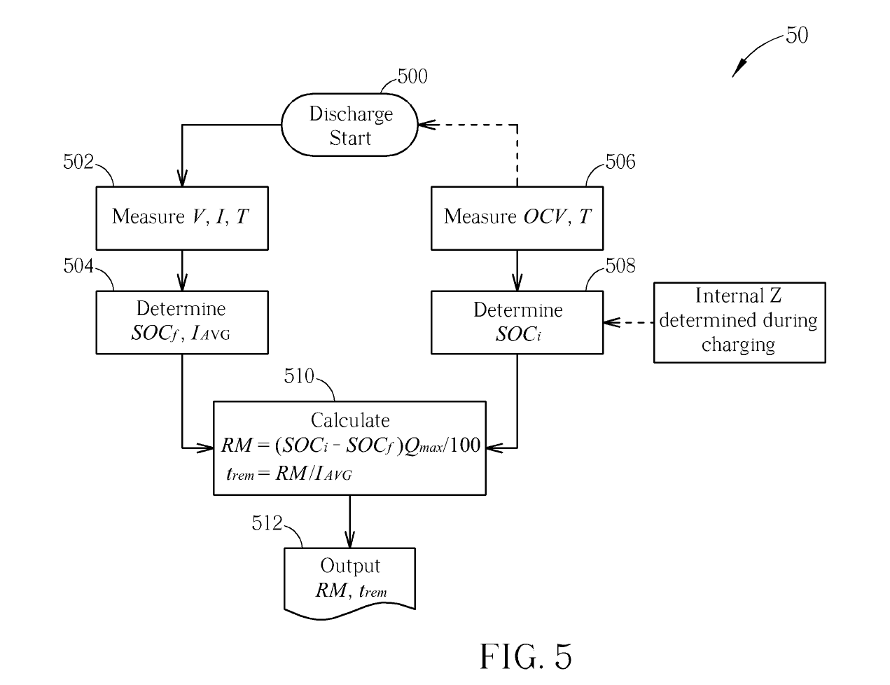

Please refer to FIG. 5, which is a flowchart of a process 50 for predicting remaining capacity and run-time of a battery of a battery device, such as the battery device 30 or the smart battery device 40. The process 50 may be performed by the adaptive control circuit 410. While the battery is being discharged (Step 500), voltage, current, and temperature of the battery are measured (Step 502). According to the measured voltage, current, and temperature, final state of charge SOC_{f} and average current I_{Avg} are determined (Step 504) through a shooting end of discharge (EOD) process. Before discharge starts, open circuit voltage (OCV) and temperature are also measured (Step 506), and initial state of charge SOCᵢ is determined through a look-up table according to the measured OCV and temperature (Step 508). Based on the final state of charge SOC_{f}, the initial state of charge SOCᵢ, and the average current I_{Avg}, remaining capacity RM and remaining run time tᵣₑₘ are calculated (Step 510), and outputted (Step 512). Remaining capacity RM and remaining run time tᵣₑₘ are calculated according to the following equations wherein Qₘₐₓ is defined as design capacity:

RM=(SOCᵢ−SOC_{f})×Qₘₐₓ/100, and (1)

tᵣₑₘ=RM/I_{Avg} (2)

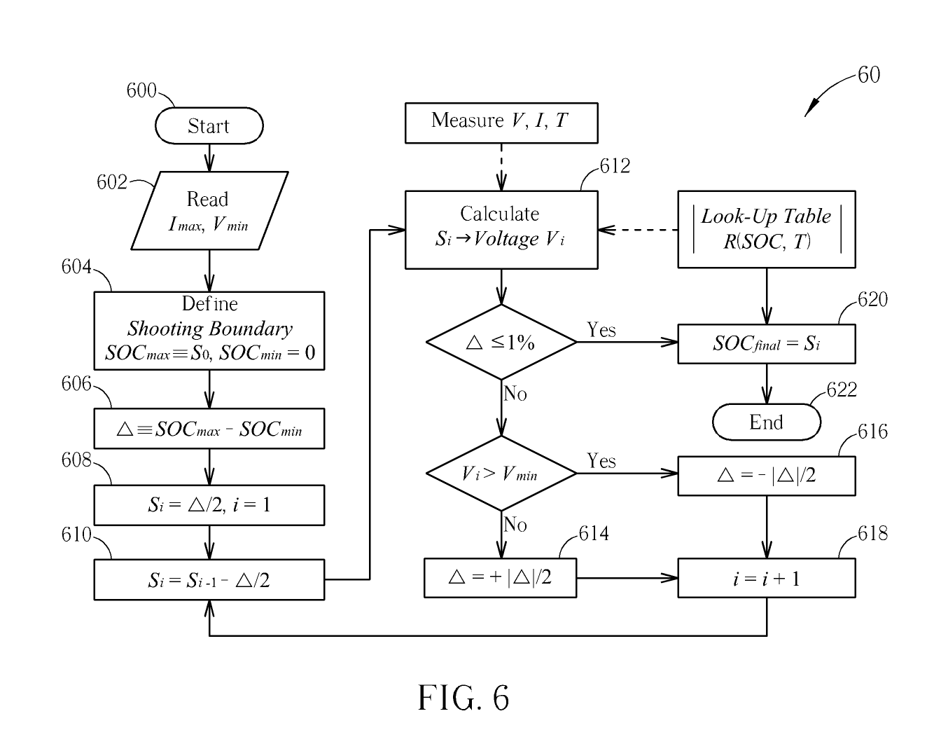

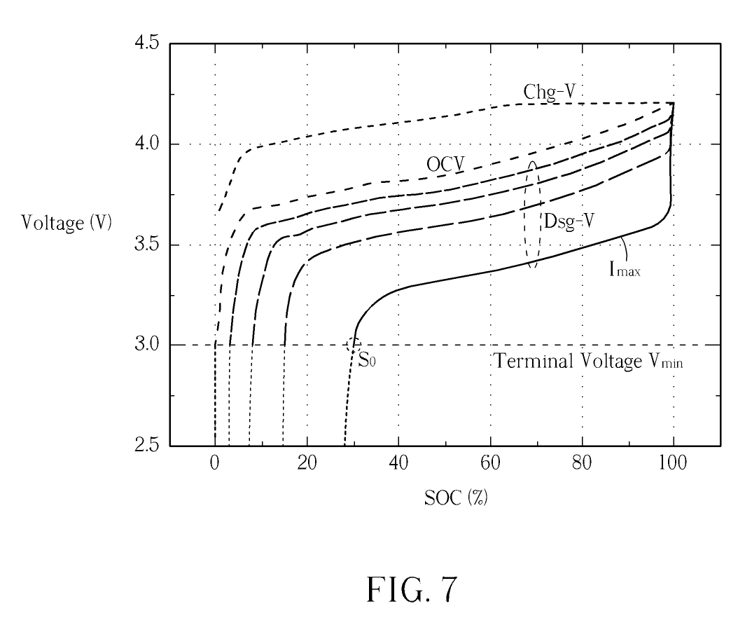

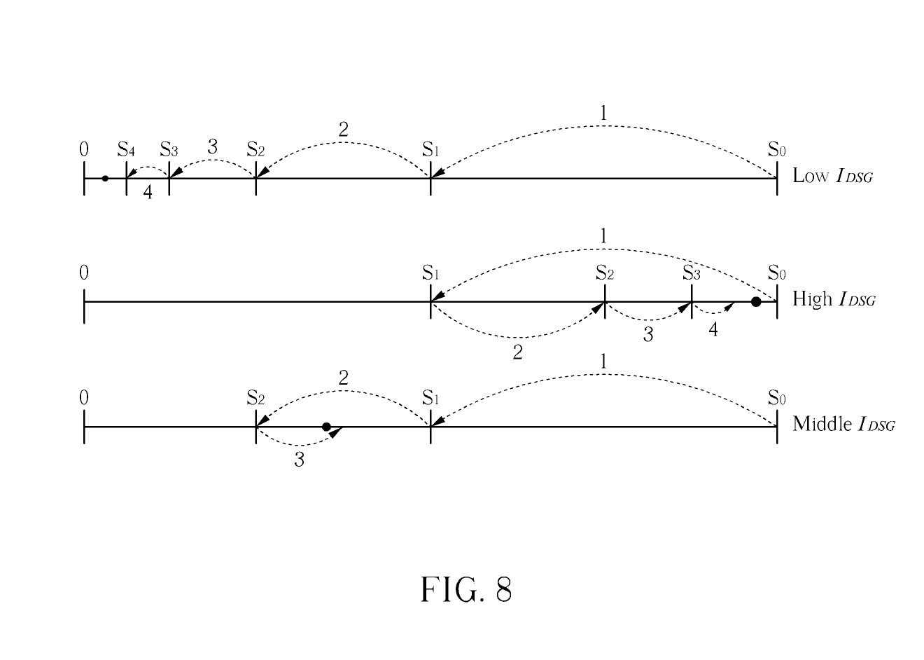

Please refer to FIG. 6, FIG. 7, and FIG. 8. FIG. 6 is a diagram of a shooting EOD process 60 according to an embodiment. FIG. 7 is a diagram illustrating estimated battery voltage versus state of charge (SOC) for various discharge currents. FIG. 8 is a diagram illustrating three cases for estimating final state of charge SOC_{final} for low, high, and middle discharge current. The shooting EOD process 60 may be utilized in Step 504 of the above process 50. When the shooting EOD process 60 starts (Step 600), maximum current Iₘₐₓ and termination voltage Vₘᵢₙ are read (Step 602) from a look-up table stored in a memory device. A shooting boundary is defined (Step 604) from a minimum state of charge SOCₘᵢₙ to a maximum state of charge SOCₘₐₓ. The minimum state of charge SOCₘᵢₙ may be set to 0%, and the maximum state of charge SOCₘₐₓ may be set to a state of charge S₀ representing state of charge when load current equals maximum current Iₘₐₓ and estimated battery voltage Vᵢ equals termination voltage Vₘᵢₙ (FIG. 7). Termination voltage Vₘᵢₙ may be a minimum operable battery voltage of the battery pack 400. Based on the minimum state of charge SOCₘᵢₙ and the maximum state of charge SOCₘₐₓ, a range Δ is defined as SOCₘₐₓ-SOCₘᵢₙ (Step 606). An SOC candidate Sᵢ is set to λ/2 (S₀/2 for i=1 and SOCₘᵢₙ=0) in Step 608, and estimated battery voltage Vᵢ is calculated for the SOC candidate Sᵢ based on resistance R obtained from a look-up table stored in the memory device (Step 612). The resistance R varies with state of charge and temperature, and may be looked up in a look-up table according to state of charge SOC and temperature T. The resistance R stored in the look-up table may be stored for discrete values of SOC and temperature. Thus, the resistance R obtained from the look-up table may be a nearest match based on the temperature T and the SOC candidate Sᵢ. Battery voltage V, discharge current I, and temperature T of the battery pack 400 may be measured continuously throughout the process 60. If Δ is less than or equal to a predetermined error threshold, such as 1%, the SOC candidate Sᵢ is taken as final state of charge SOC_{final} (Step 620), and the process 60 ends (Step 622).

The process 60 may be modified in a second embodiment as follows. The discharge current I may be converted into a termination resistance Rₘᵢₙ corresponding to the termination voltage Vₘᵢₙ through Ohm's Law as Rₘᵢₙ=Vₘᵢₙ/I. Based on the temperature T, the microprocessor 413 may utilize a similar shooting method to search the look-up table for state of charge most closely corresponding to the termination resistance Rₘᵢₙ within the range Δ defined above as SOCₘₐₓ-SOCₘᵢₙ. Thus, by calculating the termination resistance Rₘᵢₙ first, the process 60 may directly compare the termination resistance Rₘᵢₙ with the internal resistance values stored in the look-up table, without performing multiplication to determine the battery voltage corresponding to the candidate state of charge.

The estimated battery voltage Vᵢ may be calculated according to the resistance R and the discharge current I, as R×I. If Δ is greater than the predetermined error threshold, and if the estimated battery voltage Vᵢ is less than the termination voltage Vₘᵢₙ, Δ is updated to |Δ|/2 (Step 614). If Δ is greater than the predetermined error threshold, and if the estimated battery voltage Vᵢ is greater than the termination voltage Vₘᵢₙ, Δ is updated to |Δ|/2 (Step 616). In either case (Step 614 or Step 616), i is incremented by one (Step 618, i=i+1). After i is incremented (Step 618), the SOC candidate Sᵢ is reduced by Δ/2 (Step 610, Sᵢ=S₁₋₁−Δ/2). Steps 610, 612, 614/616, and 618 form an iterative loop by which final SOC SOC_{final} may be determined to within the predetermined error threshold (Step 620), as shown in FIG. 8. Number of iterations required by the process 60 to determine the final SOC SOC_{final} depends on size of the range SOCₘₐₓ-SOCₘᵢₙ, as well as size of the predetermined error threshold. For example, if the predetermined error threshold is 1%, and the range SOCₘₐₓ-SOCₘᵢₙ is between 33% and 64%, number of iterations is six (6=log₂ (64)). Number of iterations is five for the range SOCₘₐₓ-SOCₘᵢₙ between 17% and 32%, four for the range SOCₘₐₓ-SOCₘᵢₙ between 9% and 16%, and so forth. By increasing the predetermined error threshold, the number of iterations may be reduced; decreasing the predetermined error threshold may increase the number of iterations. Decreasing the range SOCₘₐₓ-SOCₘᵢₙ may reduce the number of iterations; increasing the range SOCₘₐₓ-SOCₘᵢₙ may increase the number of iterations.

It can be seen from the above description of the process 60 that, compared to the prior art, instead of requiring N iterations to determine final state of charge SOC_{final}, the process 60 may determine final state of charge SOC_{final} within log₂(SOCₘₐₓ-SOC_{min) iterations.}

Once the final state of charge SOC_{final} is determined, remaining capacity (RM) and remaining run time tᵣₑₘ may be determined according to Step 510 described above.

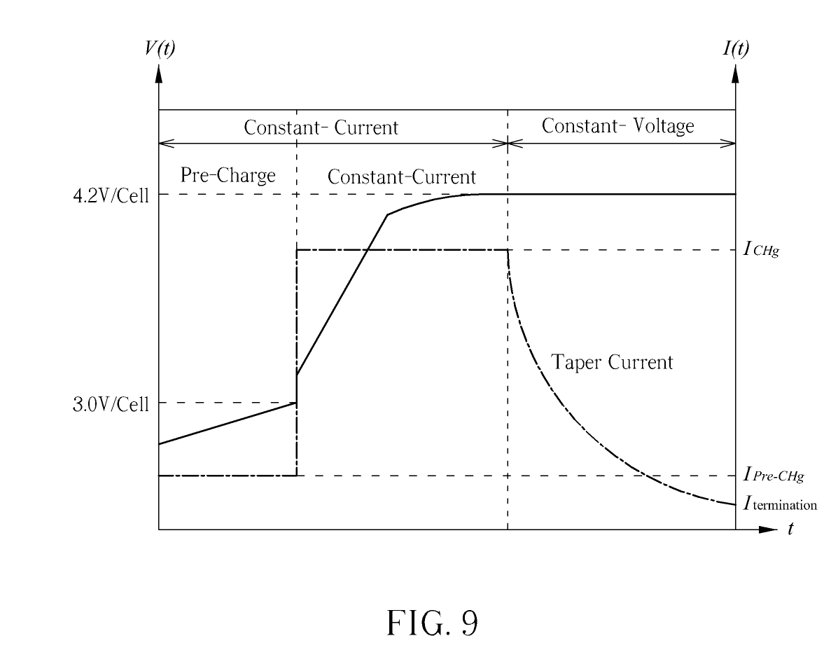

Please refer to FIG. 9, which is a diagram illustrating a typical battery charging profile. As shown in FIG. 9, a charging profile for charging a battery device, such as the battery device 400 described above, includes constant current and constant voltage charging periods. During the constant current charging period, a pre-charge current I_{Pre-Chg} is applied to charge the battery device to a first voltage, e.g. 3.0 Volts/Cell. Then, a constant charging current I_{Chg} is applied until the battery device reaches a second voltage, e.g. 4.2 Volts/Cell, at which a taper current is applied to keep constant voltage on the battery device 400, until the taper current reaches a termination current Iₜₑᵣₘᵢₙₐₜᵢₒₙ, at which time charging ends. In the above processes 50, 60, internal resistance R of the battery device 400 is measured during charging. Thus, internal resistance information stored in the look-up table is more accurate for each state of charge and each temperature, because charging current applied during charging is steadier than discharging current applied during use. Because the internal resistance information is more accurate, the final state of charge SOC_{final} determined in the process 60 is more accurate.

Thus, the processes 50, 60 described above are less prone to error due to discharge current variations, and require fewer calculations to iteratively arrive at an accurate prediction of remaining capacity and remaining run-time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of estimating remaining capacity and remaining time of a battery device during discharging of the battery device, the method comprising:
determining an initial state of charge of the battery device;
determining a discharge current of the battery device;
utilizing a shooting end of discharge process to determine a final state of charge corresponding to the discharge current; and
determining the remaining capacity and the remaining time according to the final state of charge.

2. The method of claim 1, wherein t the step of determining the discharge current of the battery device further comprises:
measuring a current flowing out of the battery device during discharging of the battery device; and
utilizing moving averaging of the current over time to generate the discharge current.

3. The method of claim 1, wherein the step of utilizing the shooting end of discharge process to determine the final state of charge corresponding to the discharge current further comprises:
establishing a look-up table comprising internal resistance values corresponding to a plurality of temperatures and a plurality of states of charge;
setting a termination voltage;
setting a maximum state of charge according to the termination voltage and a maximum discharge current of the battery device;
determining a battery voltage corresponding to a candidate state of charge in a range equal to the maximum state of charge minus the minimum state of charge according to the discharge current and the internal resistance value corresponding to the candidate state of charge;
halving the range to a half range;
decreasing the candidate state of charge by the half range when the battery voltage is less than the termination voltage;
increasing the candidate state of charge by the half range when the battery voltage is greater than the termination voltage; and
selecting the candidate state of charge when the −range is less than or equal to a predetermined error threshold.

4. The method of claim 3, wherein the step of establishing the look-up table comprising the internal resistance values corresponding to the plurality of temperatures and the plurality of states of charge further comprises:
setting a plurality of discrete points corresponding to the plurality of states of charge;
measuring battery voltage, battery current, and battery temperature at the plurality of discrete points during a charging cycle of the battery device;
calculating the internal resistance value of each discrete point as the battery voltage divided by the battery current at each discrete point; and
storing each internal resistance value in the look-up table according to the discrete point and the battery temperature at the discrete point.

5. The method of claim 1, wherein the step of determining the remaining capacity and the remaining time according to the final state of charge further comprises:
determining the remaining capacity (RM) as Design Capacity×(SOCᵢ−SOC_{f})/100, where SOCᵢ represents initial state of charge, and SOC_{f} represents final state of charge.

6. The method of claim 5, wherein the step of determining the remaining capacity and the remaining time according to the final state of charge further comprises:
determining the remaining run time as RM/I_{avg}, where RM represents the remaining capacity, and I_{avg} represents the discharge current.
